(19) United States
(12) Patent Application Publication
(10) Pub. No.: US 2009/0016584 A1
(43) Pub. Date: Jan. 15, 2009

(54) METHOD AND CONTROL EQUIPMENT TO CONTROL A MEDICAL IMAGING SYSTEM

(76) Inventors: Dieter Boeing, Forchheim (DE); Till Hoenig, Moehrendorf (DE)

Correspondence Address: SCHIFF HARDIN, LLP;PATENT DEPARTMENT, 6600 SEARS TOWER, CHICAGO, IL, 60606-6473, US

(21) Appl. No.: 12/171,339

(22) Filed: Jul. 11, 2008

(30) Foreign Application Priority Data
Jul. 11, 2007 (DE) 10 2007 032 302.8

(51) Int. Cl. G06K 9/00

(52) U.S. Cl. 382/128

(57) ABSTRACT

In a method and control equipment to control a medical technological imaging system to produce image data, several measuring request signals are transferred to the medical technological imaging system and, depending on the measuring request signals, the medical technological system is controlled to acquire raw data in a combined measurement of a subject for the different measuring request signals. For each of the measuring request signals, image data are reconstructed on the basis of the raw data. The respective sets of image data (reconstructed for the individual measuring request signals are combined in separate studies allocated to the individual measuring request signals and are stored in a storage unit and/or transferred to a diagnostic station.

### BACKGROUND OF THE INVENTION

1. Field of the Invention

The present invention concerns a method as well as control equipment to control a medical technological system in order to produce medical technological image data, and a medical technological system having such control equipment.

2. Description of the Prior Art

Today imaging systems, as, for example, CT scanners, magnetic resonance systems, etc., play an important part in the medical field. The representations of the internal organs and body structures of a patient produced by imaging systems are used to diagnose causes of disease, to plan and perform operations, or even to prepare therapeutic procedures. To this end, like magnetic resonance systems, the new generation of CT scan systems allows large-volume examinations which, in a maximum case, can consist of whole body examinations.

In order to perform an examination, the majority of clinics and larger radiological clinics first prepare examination requests, which are sent to the respective imaging system in the form of measuring request signals usually via a hospital information system, for example an RIS (Radiological Information System). Depending on the measuring request signal, the imaging system performs the measurement in order to prepare the required image data in compliance with the examination request. In the process, the measuring request signals in the RIS are often prepared in the form of a so-called “worklist” and then transferred to the respective imaging system. Depending on the clinic or clinical set-up, it is possible to enter a combination examination, for example, the frequently performed combined thoracic-abdominal examination in the worklist as individual measuring request signals or as a multiple measuring request signal.

In order to maintain certain compatibility, most systems and networks operate according to the so-called DICOM standard (DICOM=Digital Imaging and Communications in Medicine) when preparing and storing the image data. At the same time, it is possible to clearly identify by means of a so-called order number (usually also called “accession number”) each measuring request (in the DICOM standard referred to as “requested procedure”) transmitted through the RIS in the form of a measuring request signal. When performing a measurement to produce image data for a specific examination request, a so-called “study” is initiated at the imaging system. According to DICOM standard, such studies are result files which contain in the form of image series all image data produced for a specific examination request. In addition, this study contains the essential information regarding the request, including the order number. The study is then sent for diagnostic purposes to a diagnostic station where the radiologist concerned assesses the image data and, also according to DICOM standard, writes his diagnostic findings into a data file belonging to the study. At the same time, the DICOM standard has been arranged in such a way that exactly one diagnostic finding is allowed for each study. For this reason, all results of a measurement are currently stored in only one study, even if within the scope of the measurement several measuring request signals were processed and/or it was, for example, a matter of a combination examination.

This situation is shown in FIG. 1. It is a schematic representation of the situation at the RIS from which the examination requests are coming, at the imaging system (here a CT scanner) which receives the requests and performs the measuring and image reconstruction, and in the PACS (Picture Archiving and Communication System) by means of which the images produced are stored or sent to the diagnostic station. The RIS has two measuring request signals MB_{Th}, MB_{Ab} for two examination requests, here, for example, for the thoracic area and for the abdominal area. Each has its own order number AN_{Th}, IC_{Ab} and its own study identification code IC_{Th}, IC_{Ab} (also called “Study Instance UID”). Since it would be logical to combine the measurements in order to keep X-ray exposure of the patient at the lowest possible level, these studies at the CT scanner are combined into one study S which is given a new study identification code IC_{N}. The order numbers AN_{Th}, AN_{Ab}, which allow for a correlation with the original measuring request signal MB_{Th}, MB_{Ab}, are lost in the process. In this study S_{N} all image series, i.e., the image data BD_{Th} concerning the thoracic area and the image data BD_{Ab} concerning the abdominal area, are combined. Via the PACS, the study is then stored and sent to the diagnostic station.

This procedure presents the significant problem that the order number may be lost and the study identification code may be changed. In most hospital information systems and PACS systems the order number plays an important part and the loss of this number involves the loss of important information, such as decisive study descriptions, an original statement of why the respective examination has actually been requested, etc. In particular, if the image series produced were diagnosed by different experts, a reference to the original request data is lacking and, consequently, a continuous possibility to document the entire examination. This is not only a disadvantage for the clinical set-up, but also a disadvantage for the patient, since it is no longer possible to clearly allocate additional data.

Moreover, in large clinics and radiological clinics having decisive radiological divisions, for example, for the thoracic area, the abdominal area, the neurological area, etc., it is reasonable to send the image data produced for the individual requests to the respective specialist divisions. In this way, the radiologists receive only those images for diagnosis for which they have special knowledge. As a result, each radiologist can write a diagnostic report for the body section for which he received an examination request.

Because of this problematic situation, based on the original request data, frequently additional studies are later produced and the image series are then “manually” distributed to the appropriate studies. This method is shown in FIG. 2. In the RIS and at the CT scanner, the situation corresponds to the original method according to FIG. 1. However, for the purpose of storing and distribution in the PACS, the study S_{N} is now manually converted into two studies S_{Th}, S_{Ab} to which the respective image data BD_{Th}, BD_{Ab} is being assigned.

Apart from the fact that this is a method requiring extraordinary personnel costs, this solution has other serious disadvantages. For example, as long as during raw data acquisition and reconstruction of image data the data is available only at the CT scanner, it is not possible to access the request information (for example in the form of the order number) and, consequently, the original examination requests.

Another disadvantage is the fact that it is not possible to use the so-called MPPS service (MPPS=Modality Performed Procedure Step). By means of the MPPS modules appropriate for this service and provided according to DICOM standard, important data, as, for example, the dose applied, the required items to be used, in particular contrast agents, etc., and especially also the information which data was the most recent to be produced on the device, can be immediately transmitted to a central system and/or a clinical information system, where they are documented and used for further analysis. Since with the method depicted in FIG. 2, the data has only a temporary status at the medical technological system itself and the image series are later moved to different studies, the required MPPS signal cannot occur here. Otherwise, it would later result in inconsistencies between the RIS and the PACS.

### SUMMARY OF THE INVENTION

An object of the present invention is to provide an alternative, user-friendly method and an appropriate control equipment to control a medical technological imaging system in order to produce image data by means of which the above-mentioned disadvantages can be avoided.

The above object is achieved in accordance with the present invention by a method and control equipment for controlling a medical imaging system, wherein measurement request signals are supplied to the medical imaging system and, dependent on the measurement request signals, the medical imaging system is operated to acquire raw data from a subject respectively for the different measurement request signals in a combined data acquisition procedure for the subject. The data are represented as respective raw data sets for the different measurement request signals. An image data set is reconstructed from each of the raw data sets, and the respective image data sets are combined in separate studies respectively allocated to the different measurement request signals. The image data sets are made available in a form for storage in a storage unit or transfer to a diagnostic station.

By means of the inventive method, the medical system is controlled to cause that raw data for the various measuring request signals are acquired in a combined measurement if, depending on the measuring request signals, several measuring request signals are transmitted to the medical technological imaging system. In this way it is guaranteed that no unnecessary measurements are required, which would involve additional exposure for the patient. For each of the measuring request signals, image data is reconstructed on the basis of the raw data and, in the process, the image data reconstructed for each of the individual measuring request signals is combined in separate studies allocated to the individual measuring request signals. These image data are stored in a storage unit for later diagnosing and/or directly transmitted to a diagnostic station.

Differing from previous methods promulgated through standard setting bodies, the image series for the individual requests are not combined in one study. Instead they are from the outset processed separately at the medical technological system. All request attributes, in particular the order number and all related information, such as, the reason for performing the examination, can be transferred to the respective studies one-to-one and are thus available from the outset to the person performing the examination. Accordingly, they can also be recorded properly. In particular is it possible to produce in customary fashion MPPS data for the examination and to allocate them to the respective studies. These MPPS data are continuously consistent and can be analyzed appropriately in the RIS and PACS.

The separate usage of the individual measuring request signals in reconstructing image data and allocating them to the various studies especially guarantees that, on the part of the RIS, all planning data can be stored in the respective studies. It is possible to send the studies produced selectively to specialized diagnostic stations. A particular advantage of this method can be seen in the fact that there is no infringement on existing data standards. Instead, the image data and image series produced or studies prepared with the new method are valid in terms of standard.

In order to perform the method, inventive control equipment to control a medical technological imaging system must have an appropriate interface to collect several measuring request signals for a measurement to be performed. It also has acquisition control equipment which, in dependence on the measuring request signals, controls the medical technological system in such a way that raw data for the different measuring request signals are acquired in a combined measurement. According to the invention, the control equipment also has an image data reconstruction unit which reconstructs image data for each of the measuring request signals on the basis of the raw data. At the same time, each of the image data reconstructed for the individual measuring request signals is combined in separate studies allocated to the individual measuring request signals, i.e., appropriately collected and stored in a storage unit and/or sent to different units via a network or provided to be used in a PACS.

In addition to the usual components for acquiring data, i.e., a CT scanner for a CT scan or an MR scanner for an MRI, the invention-based medical technological imaging system requires control equipment arranged according to the invention.

Preferably the imaging system is a CT scan system since, because of the X-ray exposure, it is especially important in the context of such systems that different examinations are preferably performed within one measurement.

The majority of the previously mentioned components of the control equipment, in particular the acquisition control unit and the imaging data reconstruction unit, can be realized as a whole or in part in the form of software modules in a processor of the control equipment. This is advantageous in that, through an installation of the software, it is possible to retrofit already existing control equipment for the purpose of performing the invention-based method. Hence, the invention involves also a computer program which can be directly loaded with program code means in a processor of programmable control equipment of a medical technological imaging system, in order to perform all steps of the invention-based method if the program has been implemented in the control equipment.

Other especially advantageous embodiments and developments of the invention result from the dependent claims and the following description. At the same time, the invention-based control equipment or invention-based medical technological imaging system can also be developed analogous to the dependent procedural claims.

In an especially preferred embodiment of the invention-based method, first of all, prior to the measurements at the imaging system, a study is produced for each measuring request signal to which later the appropriate image data is being allocated. Preferably, an identification code assigned to the measuring request signal can be automatically connected to the appropriate study, so that at each point in time a connection exists between the original measuring request and the image data produced for this purpose.

In a preferred embodiment, similar image data to be produced for different measuring request signals are reconstructed only once, and copies of these image data are prepared for the different studies and allocated to the various studies. The kind of image data this will be depends on the type of examinations to be performed. A typical example is the overview screen, also called “topogram” to be prepared in the context of almost each measurement. This is usually determined by a pre-measurement prior to the actual main measurement. Then, by means of the topogram, it can be determined in what area what kind of images, for example, how many layers with what distance, should be produced. Consequently, with this method, in a raw data acquisition in a separate pre-measurement, at first raw data for reconstructing overview image data are being acquired. Preferably, the overview image data determined are copied and allocated to the different studies. In addition, a documentation of the examination, the so-called “patient protocol,” can be copied and allocated to the appropriate studies.

In a preferred procedure, after an acquisition of raw data, the respective image data for the different measuring request signals are successively reconstructed from the raw data in separate reconstruction cycles and combined in the study allocated to the respective measuring request signal. This means, for example, that, after the raw data acquisition, in a first reconstruction cycle, all image data for a first measuring request signal is reconstructed and stored in a first study. Afterwards, in a second reconstruction cycle, all image data for a second measuring request signal are reconstructed and stored in a second study. This procedure is continued until the respective image series for each measuring request signal is reconstructed and stored in the respective study.

Usually, different measuring protocols or control reports are available in medical technological systems, as, for example, CT scanners and MRIs, in which it is determined for specific kinds of examinations by means of which control parameters the measurements will be performed. All the user has to do is select one of these measuring protocols, modify if necessary the stored control data and the following measurement is then automatically performed on the basis of this measuring protocol. This means that the medical technological system is ultimately controlled on the basis of this measuring protocol.

In the inventive method, several measuring protocols for different measuring request signals are therefore stored preferably in a storage unit, whereas additionally the measuring protocols include control data for image reconstruction and the reconstructed image data is allocated to the respective studies. This means that, based on the measuring request signals, the user can select an appropriate measuring protocol, which is able to control the medical technological system in such a way that a single measurement is performed for all measuring request signals, and which also automatically controls reconstruction in such a way that the respective image series are produced for the different measuring request signals and automatically combined in the appropriate studies. This would considerably alleviate the series of operations for the user of the system.

### BRIEF DESCRIPTION OF THE DRAWINGS

FIG. 1 is a diagram illustrate to preparation a study from different examination requests as they are currently performed according to prior art.

FIG. 2 is a diagram illustrating how, according to prior art, a study produced according to the method in FIG. 1 is again separated into two studies.

FIG. 3 is a diagram of an embodiment of the inventive method to produce two different studies for two different examination requests.

FIG. 4 is a flowchart for an embodiment of the inventive method.

FIG. 5 is a schematic illustration of an imaging system with an embodiment of the inventive control equipment in order to perform the method.

### DESCRIPTION OF THE PREFERRED EMBODIMENTS

The following explanations assume that the imaging system is a CT scan system. However, the method can basically also be used for other imaging systems.

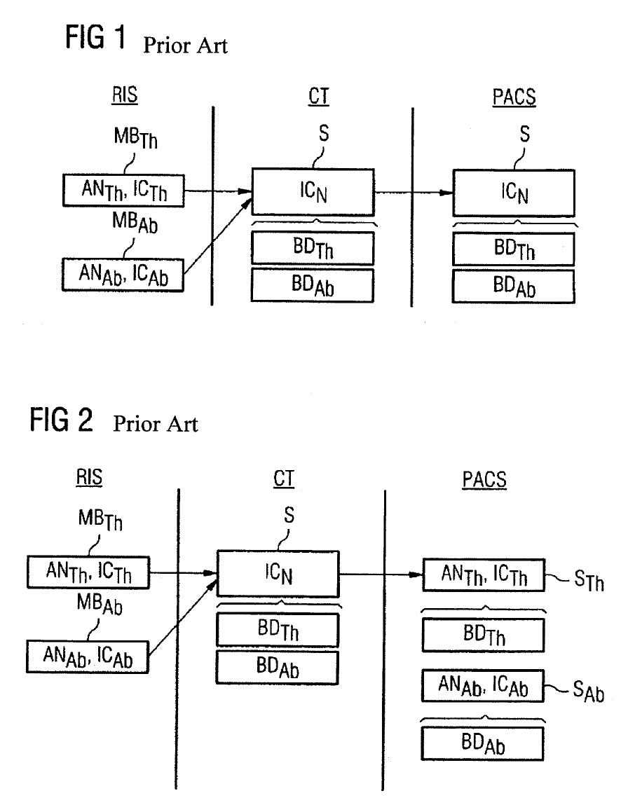

The method according to FIGS. 1 and 2 as currently performed in prior art has already been explained in detail. FIG. 1 shows the method originally designed according to DICOM standard in which two examination requests, for example, for a thoracic examination and an abdominal examination, are being combined by the CT scanner, and ultimately the image series combined in a study S is transferred to the PACS. FIG. 2 shows a somewhat altered variation in which, just as in the method according to FIG. 1, the image series for both examination requests are first of all combined in a study S by the CT scanner, and subsequently they are separated again manually into two studies S_{Th}, S_{Ab}. As previously explained, this method causes not only considerable effort but involves also other disadvantages, in particular unavailable allocation and indistinct documentation of the entire examination.

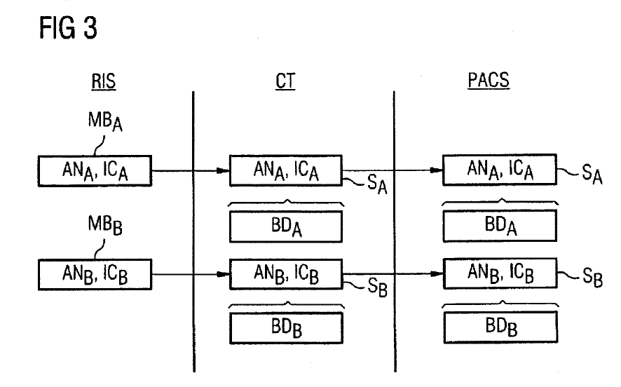

FIG. 3 shows that, with the invention-based method, the system is controlled in such a way that already at the CT scanner, i.e., during raw data acquisition and particularly during subsequent reconstruction, for each of the measuring request signals MB_{A}, MB_{B} transferred by the RIS automatically a separate study S_{A}, S_{B} is being produced. In the process, the image data BD_{A} for the first measuring request signal MB_{A} are combined in the first study S_{A} and the image data BD_{B} for the second measuring request signal MB_{B} are combined in the second study S_{B}. These separate studies are then transferred to the PACS, and there they can be handled completely separately. However, it has to be guaranteed that in the studies S_{A}, S_{B} transferred to the PACS none of the attributes of the original measuring request signals MB_{A}, MB_{B} are lost but that they are allocated to the respective studies S_{A}, S_{B}. However, by means of the inventive method at the CT system itself, it is guaranteed that the actual data acquisition is performed in combined fashion and the exposure of the patient will be kept at a minimum.

As shown in FIG. 3, each measuring request signal MB_{A}, MB_{B} is supplied with an order number AN_{A}, AN_{B} and is also equipped with a study identification code IC_{A}, IC_{B}. At the CT scanner, the order number AN_{A}, AN_{B} as well as the study identification code IC_{A}, IC_{B} are immediately allocated to the different studies S_{A}, S_{B} and are consequently later available in the PACS. As a result, clear allocation to the original examination request or measuring request signals MB_{A}, MB_{B} can be guaranteed.

In comparison to FIGS. 1 and 2, FIG. 3 shows merely one example with only two measuring request signals MB_{A}, MB_{B}. However, it is certainly possible to send more than two measuring request signals or examination requests to the CT scanner for only one measurement and to perform a combined measurement of raw data for these examination requests.

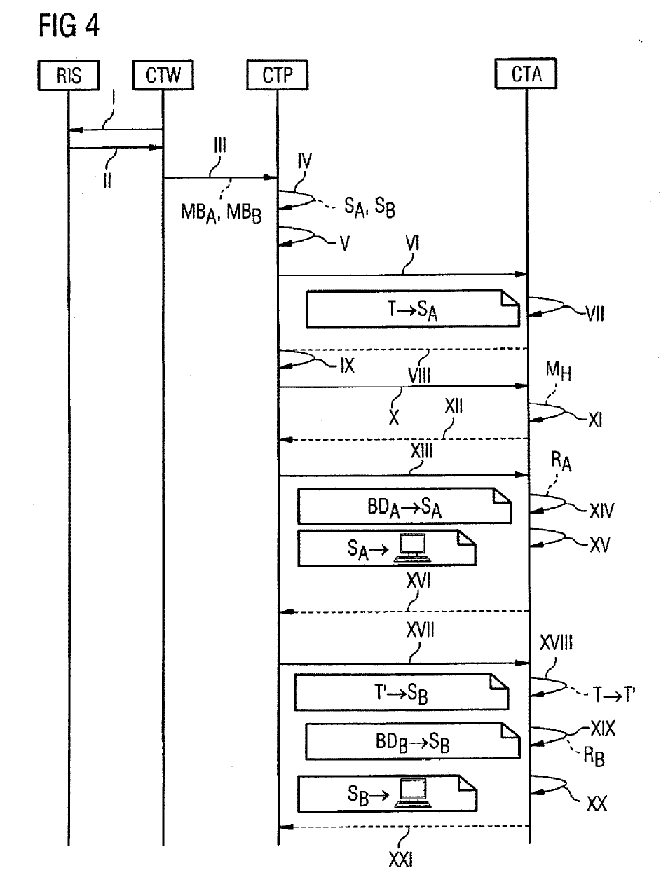

FIG. 4 shows a possible process of the invention-based method, in particular at the CT scanner itself. On the one hand, the data transfer from the RIS in a so-called CT worklist database CTW of the CT scanner. During the examination at the CT scanner, this CT worklist database CTW can be accessed in order to plan (charted as CTP range) the measurement to be performed, and ultimately to perform the actual data acquisition CTA. Consequently, the CT worklist database CTW forms the interface between the RIS and the actual CT scanner where the CT acquisition planning CTP and the CT acquisition CTA takes place.

In a first step I, the actual worklist is requested from the CT at the RIS. In step II, the worklist is sent. This worklist contains several measuring requests for the CT scanner, usually arranged according to patients, whereas, among other things, it can contain also several measuring request signals for the same patient.

If, in step III, the user of the CT scanner selects a patient for whom several measuring request signals MB_{A}, MB_{B} are provided, these measuring request signals MB_{A}, MB_{B} are transferred to the CT acquisition planning CTP and must be taken into consideration for the measurement to be performed.

In step IV, during CT acquisition planning CTP at the CT scanner, two studies S_{A}, S_{B} are already prepared whereas these are initially folders to which only the data of the respective measuring request signals MB_{A}, MB_{B}, such as order numbers AN_{A}, AN_{B} are assigned but not yet any image data. Subsequently, in step V, one or several appropriate examination reports are selected in order to perform the examinations provided according to the measuring request signals MB_{A}, MB_{B}, i.e., to acquire the required raw data and reconstruct from these the image data.

In step VI, appropriate control commands for measuring a topogram are sent to the CT scanner. In step VII, the actual acquisition of the raw data for the topogram is performed in a pre-measurement M_{V} and, at the same time, the reconstruction of overview screen data for the purpose of preparing the topogram T. Preferably, this topogram T is initially stored in a study to which the next topogram entry is allocated in the report, for example, to the first study S_{A}.

After, in step VIII, the pre-measurement and topogram image data production has been concluded, the actual main measurement M_{H} can be planned in step IX so that, in step X, the respective control commands for the CT acquisition are being sent to the CT scanner.

Subsequently, in step XI, the actual main measurement is being performed. This can be, for example, a whole-body spiral measurement so that sufficient data is being recorded to produce the image data for the first examination request MB_{A}, for example, the thoracic examination, and the second measuring request signal MB_{B}, for example, an abdominal examination. In step XII, the raw data is stored for later reconstruction.

The user can perform steps IV, V, IX at the control unit of the CT scanner manually, semi-automatically or even automatically. Usually the selection of the image series to be produced and their allocation to a request or study for a specific examination request has to be performed only once, and in subsequent examinations, which are based on the requests with similar examination combinations, the selection is performed automatically. However, among other things, this also depends on the form in which previously appropriate measuring protocols have been stored in order to perform measurements for different combinations of measuring request signals.

After, in step XII, the raw data have been made available, in step XIII, a proportionate spiral reconstruction for the study S_{A} can be initialized and performed in a first reconstruction cycle R_{A}. For this purpose, the image data BD_{A}, i.e., an image series, for the first measuring request signal MB_{A} is reconstructed whereas the images are referenced in the existing topogram T. The image data BD_{A} is then stored in the study S_{A} together with the topogram T already arranged in the study S_{A}. In step XV, for example, the entire study S_{A} is sent to a diagnostic station for the respective request type, for example, in case of a thoracic examination to a specialist division for thoracic examinations.

In step XVI, the image data reconstruction for the first study S_{A} is being concluded and, in step XVII, a proportionate spiral reconstruction can be initialized for the second study S_{B}, for example, an abdominal examination. To this end, in a first step XVIII, a copy of the previous topogram T is produced and this topogram copy T′ is stored in the study S_{B}. Subsequently, in step XIX, a new image series is reconstructed, i.e., the image data BD_{B} for the second study S_{B} are produced and, in step XX, these image data are also stored in the study S_{B} for the topogram Tp′. At the same time, the copied topogram T′ contains also the references for the produced image data BD_{B} of the second study S_{B}. In step XX, the entire study S_{B} is transferred to a further diagnostic station, for example, a diagnostic station in a specialist division for abdominal examinations. In step XXI, the entire examination is concluded.

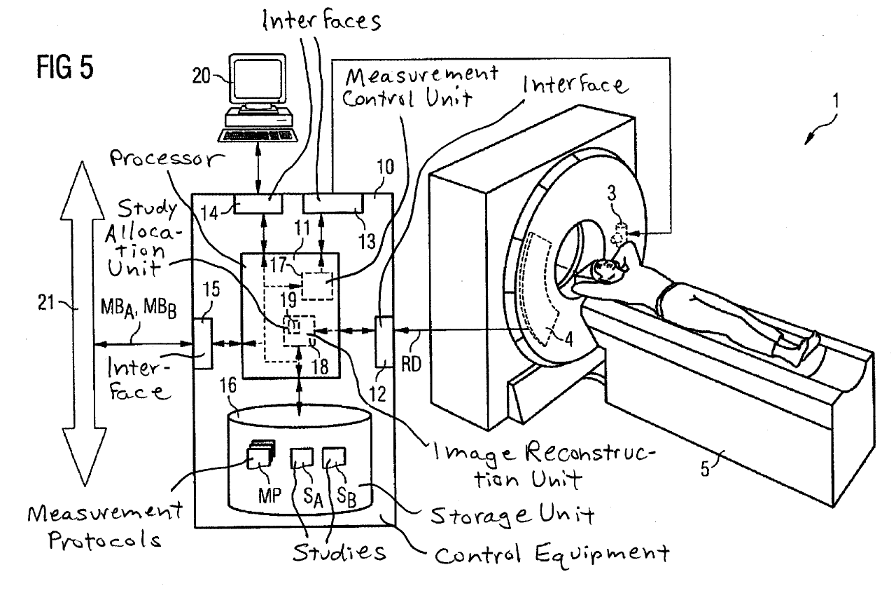

FIG. 5 shows a rough diagram of a CT scan system 1 having control equipment 10 to perform the invention-based method. In customary fashion, the CT scan system 1 features a scanner 2 having a gantry in which an X-ray source 3 is rotating which radiates a respective patient who is moved on a stretcher 5 into the measuring room of the gantry so that the radiation hits a detector positioned opposite of the respective X-ray source 3. Special emphasis is placed on the fact that the embodiment according to FIG. 5 is merely an example of a CT scanner. It is also possible to use the invention on any CT construction having, for example, circular fixed X-ray detectors and/or several X-ray sources.

In the same way, in the control equipment 10, only those components are represented which contribute to explaining the invention. Basically, such CT systems and respective control equipment are known to the expert and must therefore not be explained in detail.

In this context, a basic component of the control equipment 10 is a processor 11 on which different components are realized in the form of software modules. The control equipment 10 also has a terminal interface 14 to which a terminal 20 is connected by means of which a user can operate the control equipment 10 and, consequently, the CT scan system. A further interface 15 is the network interface to connect to a data bus 21 in order to establish a connection to a RIS or PACS. By means of this bus 21, the measuring request signals MB_{A}, MB_{B} can, for example, be accepted and then, by means of the terminal 20 be selected for a measurement to be performed.

Via a control interface 13, the scanner 2 can be actuated by the control equipment 10, i.e., controlling, for example, the rotation speed of the gantry, the adjustment of the patient's stretcher 5 and even the X-ray source 3. Via an acquisition interface 12, the raw data RD are read from the detector 4. The control equipment 10 has also a storage unit 16 which stores, among other things, different measuring protocols MP.

Among other things, a measuring control unit 17 has been implemented as a software component on the processor 11. On the basis of one or several selected measuring protocols MP, which, if required, have been modified by the user via the terminal 20, this measuring control unit 17 actuates by means of the control interface 13 the scanner 2 in order to perform a measurement and to acquire data.

A further component on the processor 11 is an image data reconstruction unit 18 by means of which the required image data is being reconstructed via the raw data RD obtained from the data acquisition interface 12. This image data reconstruction unit 18 has a study allocation unit 19 in the form of a software module which ensures that the reconstructed image data are being allocated for a specific measuring request signal MB_{A}, MB_{B} of an appropriate study S_{A}, S_{B}. This study allocation unit 19 also has the function that reconstructed image data which are required in both studies S_{A}, S_{B}, for example a topogram, is sufficiently copied and allocated to the respective studies.

Then the concluded studies S_{A}, S_{B} can be stored or buffered, for example, in the storage unit 16. They also can be transferred via the data bus 21 immediately or later from the storage unit 16 to diagnostic stations, mass storage units or other output units and workstations, i.e., ultimately they can be transferred to the PACS.

In the methods described above, the CT scan system 1 itself (or the control unit of the CT scan system 1) prepares the examination results in the form of studies S_{A}, S_{B} precisely in the manner in which the RIS originally structured the examination requests in the form of measuring request signals MB_{A}, MB_{B}. The great advantage of this method is that the CT scan system orients itself on the order structure of the RIS. This provides clinics and radiological clinics with the flexibility to define requests in a way that is most practical for them. As a result, it is possible to prepare requests which can be performed with merely one measurement and which can be automatically allocated to the appropriate places. In the process, it is also possible to combine two dedicated individual requests first on the CT scan system for a measurement, provided they are suite for this. It is also possible to process, like previously, the dedicated requests separately. However, as far as possible in order to keep X-ray exposure at a low level, all requests are preferably combined in one measurement in order to avoid unnecessary acquisition of raw data. Because of the high flexibility, it is possible to have patient-specific deviations from previously arranged standard methods in which specific measuring request signals were defined for particular patients and sent to the respective CT scan systems. At a diagnostic station, it is easy be retrieve the image series performed with an invention-based method, allowing for an allocation by using the original order number.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for controlling a medical imaging system comprising the steps of:
supplying measurement request signals to a medical imaging system;
dependent on the measurement request signals, operating the medical imaging system to acquire raw data from a subject respectively for the different measurement request signals in a combined data acquisition procedure for the subject, said data being represented as respective raw data sets for the different measurement request signals; and
from each of said raw data sets, reconstructing an image data set therefrom, and combining the respective image data sets in separate studies respectively allocated to the different measurement request signals, and making the image data sets available for storage in a storage unit or transfer to a diagnostic station.

2. A method as claimed in claim 1 comprising prior to implementing said data acquisition procedure at said imaging system, producing a study for each of said measurement request signals to which the respective image data sets are subsequently allocated.

3. A method as claimed in claim 2 comprising identifying similar image data that is needed for the respective different measurement request signals and reconstructing an image data set only once for all of said similar image data, and making copies of the reconstructed data set for the similar image data for each of the different studies requiring said similar image data.

4. A method as claimed in claim 3 comprising, during the acquisition procedure for said raw data, implementing a pre-measurement to acquire pre-measurement raw data, and reconstructing overview image data from said pre-measurement raw data, and copying said overview image data into each of the respectively different studies.

5. A method as claimed in claim 1 comprising, after acquisition of said raw data sets, successively reconstructing the respective image data sets from the respective raw data sets in separate reconstruction cycles.

6. A method as claimed in claim 1 comprising allocating respectively different, unique identification codes respectively to said measurement request signals, and combining the respective identification code with the study associated with the measurement request signal allocated thereto.

7. Control equipment for controlling a medical imaging system comprising:
an interface that receives measurement request signals to the medical imaging system;
a control unit that, dependent on the measurement request signals, operates the medical imaging system to acquire raw data from a subject respectively for the different measurement request signals in a combined data acquisition procedure for the subject, said data being represented as respective raw data sets for the different measurement request signals; and
a computer that, from each of said raw data sets, reconstructs an image data set therefrom, and combines the respective image data sets in separate studies respectively allocated to the different measurement request signals, and makes the image data sets available via an output interface for storage in a storage unit or transfer to a diagnostic station.

8. Control equipment as claimed in claim 7 comprising a memory, accessible by said acquisition control unit, having a plurality of different measurement protocols respectively for different measurement request signals stored therein, each measurement protocol containing control data for image reconstruction associated with the respective measurement protocol.

9. A medical imaging system comprising:
a data acquisition unit configured to interact with a subject to acquire raw data therefrom; and
control equipment configured to control said data acquisition unit comprising an interface that receives measurement request signals to the data acquisition unit, a control unit that, dependent on the measurement request signals, operates the data acquisition unit to acquire raw data from a subject respectively for the different measurement request signals in a combined data acquisition procedure for the subject, said data being represented as respective raw data sets for the different measurement request signals, and from each of said raw data sets, reconstructing an image data set therefrom, and a computer that combines the respective image data sets in separate studies respectively allocated to the different measurement request signals, and makes the image data sets available via an output interface for storage in a storage unit or transfer to a diagnostic station.

10. A computer-readable medium encoded with programming instructions for controlling a medical imaging system, said medical imaging system having computerized control equipment associated therewith in which said medium is loaded, and said programming instructions causing said computerized control equipment to operate said medical imaging system to:
receive measurement request signals to the a medical imaging system;
dependent on the measurement request signals, acquire raw data from a subject respectively for the different measurement request signals in a combined data acquisition procedure for the subject, said data being represented as respective raw data sets for the different measurement request signals; and
from each of said raw data sets, reconstruct an image data set therefrom, and combine the respective image data sets in separate studies respectively allocated to the different measurement request signals, and make the image data sets available for storage in a storage unit or transfer to a diagnostic station.
